(19) United States
(12) Patent Application Publication
(10) Pub. No.: US 2026/0087825 A1
(43) Pub. Date: Mar. 26, 2026

(54) SEMANTIC GUIDED EFFICIENT PERSPECTIVE VIEW TO BEV PROJECTION AND SAMPLING

(71) Applicant: QUALCOMM Incorporated, San Diego, CA (US)

(72) Inventors: Meysam Sadeghigooghari, Linköping (SE); Ahmed Kamel Sadek, San Diego, CA (US); Tae Hoon Kim, Seoul (KR)

(21) Appl. No.: 18/893,249

(22) Filed: Sep. 23, 2024

(51) Int. Cl. G06V 20/58; G06V 10/25; G06V 10/26; G06V 10/80

(52) U.S. Cl. CPC G06V 20/58; G06V 10/25; G06V 10/26; G06V 10/806

(57) ABSTRACT

A device for processing frame data may be configured to identify one or more semantic characteristics for the frame data, wherein the frame data comprises a plurality of frames, each frame of the plurality of frames being acquired for a same scene and by a different frame source of a plurality of frame sources; extract features from each respective frame of the plurality of frames; determine a non-uniform sampling pattern of the plurality of frames based on the one or more semantic characteristics; and project, using the non-uniform sampling pattern, a portion of the extracted features into a bird's-eye-view (BEV) space having a grid structure to generate a fused set of BEV features.

### TECHNICAL FIELD

This disclosure relates to sensor systems, including sensor systems for advanced driver-assistance systems (ADAS).

### BACKGROUND

An autonomous driving vehicle is a vehicle that is configured to sense the environment around the vehicle, such as the existence and location of other objects, and to operate without human control. An autonomous driving vehicle may include multiple cameras that produce image data that may be analyzed to determine the existence and location of other objects around the autonomous driving vehicle.

In some examples, the output of multiple cameras is fused together to form a single fused image (e.g., a bird's eye view (BEV) image). Various tasks may then be performed on the fused image, including image segmentation, object detection, depth detection, and the like. A vehicle having advanced driver-assistance systems (ADAS) is a vehicle that includes systems which may assist a driver in operating the vehicle, such as parking or driving the vehicle. The ADAS may use the outputs of the tasks performed on the fused image described above to make autonomous driving decisions.

### SUMMARY

The present disclosure relates to techniques and devices for generating a fused image (e.g., BEV image) having fused features from a plurality of different cameras or other sensors. A system may extract a respective set of features from respective images from a plurality of different cameras. The system may fuse the extracted features of the images into a single set of BEV features having a grid structure. Existing techniques for fusing images sample features from the image uniformly. That is, for a uniform grid overlaying the image, samples are taken equally from each grid space. This disclosure describes techniques for determining semantic characteristics, either associated with the images or determined independently of the images, and performing non-uniform based sampling of the images based on the semantic characteristics.

A typical perspective view image may include a variety of features. For example, when driving down a road, a camera of an ADAS may capture an image that includes road defined by lane markings as well as landscaping surrounding the road. For navigating an automobile, the features corresponding to road may be of more interest to the ADAS than the landscaping features. Applying uniform sampling to features in a perspective image potentially wastes valuable computing resources on portions of the image that are of less value to the ADAS. By applying non-uniform based sampling based on semantic characteristics as described in this disclosure, an ADAS may generate better BEV representations. That is the BEV representations may have higher resolution and more detail in portions of the BEV image, such as the portions corresponding to road, that are more integral to navigation.

In the framework of this disclosure, a semantic characteristic generally refers to any sort of information, context, feature, or other piece of information that may be used to aid an ADAS in determining what features of an image may be of high value to an ADAS. The semantic characteristics may be determined directly from the perspective view of an image or may be determined independently from the image content, such as from maps (maps, e.g., an SD map or HD map), planning trajectories, predicted agents trajectories, vehicle-to-everything (V2X) data from other vehicles, or other such sources. For example, a semantic characteristic may be the presence of an object, such as a traffic light, a lane marker, a pedestrian, or the like, in an image. A semantic characteristic may also, for example, be a determination that an object is present in an image based on map data determined for a location associated with the picture.

According to an example of this disclosure, an apparatus for processing frame data includes a memory for storing the frame data and processing circuitry in communication with the memory, wherein the processing circuitry is configured to: identify one or more semantic characteristics for the frame data, wherein the frame data comprises a plurality of frames, each frame of the plurality of frames being acquired for a same scene and by a different frame source of a plurality of frame sources; extract features from each respective frame of the plurality of frames; determine a non-uniform sampling pattern of the plurality of frames based on the one or more semantic characteristics; and project, using the non-uniform sampling pattern, a portion of the extracted features into a bird's-eye-view (BEV) space having a grid structure to generate a fused set of BEV features.

According to an example of this disclosure, a method for processing frame data includes identifying one or more semantic characteristics for the frame data, wherein the frame data comprises a plurality of frames, each frame of the plurality of frames being acquired for a same scene and by a different frame source of a plurality of frame sources; extracting features from each respective frame of the plurality of frames; determining a non-uniform sampling pattern of the plurality of frames based on the one or more semantic characteristics; and projecting, using the non-uniform sampling pattern, a portion of the extracted features into a bird's-eye-view (BEV) space having a grid structure to generate a fused set of BEV features.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with one to more techniques of this disclosure.

FIG. 2 is a block diagram illustrating an encoder-decoder architecture for fusing features from a plurality of cameras in accordance with one or more techniques of this disclosure.

FIG. 3A shows an example of uniform sampling on a perspective view image.

FIG. 3B shows an example of non-uniform sampling on a perspective view image in accordance with techniques of this disclosure.

FIG. 4 is a flowchart illustrating an example process for projecting extracted features into a bird's-eye-view space according to techniques of this disclosure.

### DETAILED DESCRIPTION

Camera images from a plurality of different cameras may be used together in various different robotic, vehicular, and virtual reality (VR) systems. One such vehicular application is an advanced driver assistance system (ADAS). ADAS is a system that may perform object detection and/or image segmentation processes on camera images to make autonomous driving decisions, improve driving safety, increase comfort, and improve overall vehicle performance. An ADAS may fuse images from a plurality of different cameras into a single view (e.g., a bird's eye view (BEV)) to provide a more comprehensive view of a vehicle's surroundings, enabling the ADAS to better assist the driver in various driving scenarios.

The present disclosure relates to techniques and devices for generating a fused set of BEV features from a plurality of different cameras or other sensors. A system may extract a respective set of features from respective images from a plurality of different cameras. The system may fuse the extracted features of the images into a single fused image having a grid structure. Existing techniques for fusing images sample features from the image uniformly. That is, for a uniform grid overlaying the image, samples are taken equally from each grid space. This disclosure describes techniques for determining semantic characteristics, either associated with the images or determined independently of the images, and performing non-uniform based sampling of the images based on the semantic characteristics.

A typical perspective view image may include a variety of features. For example, when driving down a road, a camera of an ADAS may capture an image that includes road defined by lane markings as well landscaping surrounding the road. For navigating an automobile, the features corresponding to road may be of more interest to the ADAS than to the landscaping features. Applying uniform sampling to features in a perspective image potentially wastes valuable computing resources on portions of the image that are of less value to the ADAS. By applying non-uniform based sampling based on semantic characteristics as described in this disclosure, an ADAS may generate better BEV representations. That is the BEV representations may have higher resolution and more detail in portions of the BEV image, such as the portions corresponding to road, that are more integral to navigation.

In the framework of this disclosure, a semantic characteristic generally refers to any sort of information, context, feature, or other piece of information that may be used to aid an ADAS in determining what features of an image may be of high value to an ADAS. The semantic characteristics may be determined directly from the perspective view of an image or may be determined independently from the image content, such as from maps (maps, e.g., an SD map or HD map), planning trajectories, predicted agents trajectories, vehicle-to-everything (V2X) data from other vehicles, or other such sources. For example, a semantic characteristic may be the presence of an object, such as a traffic light, a lane marker, a pedestrian, or the like, in an image. A semantic characteristic may also, for example, be a determination that an object is present in an image based on map data determined for a location associated with the picture.

For ease of explanation, the techniques of this disclosure will be described using images acquired by cameras. It should be understood, however, that the techniques of this disclosure may also be used in conjunction with other frames of data, such as radar frames and Light Detection and Ranging (LiDAR) frames, that are acquired by other frame sources, such as radar devices and LiDAR devices respectively.

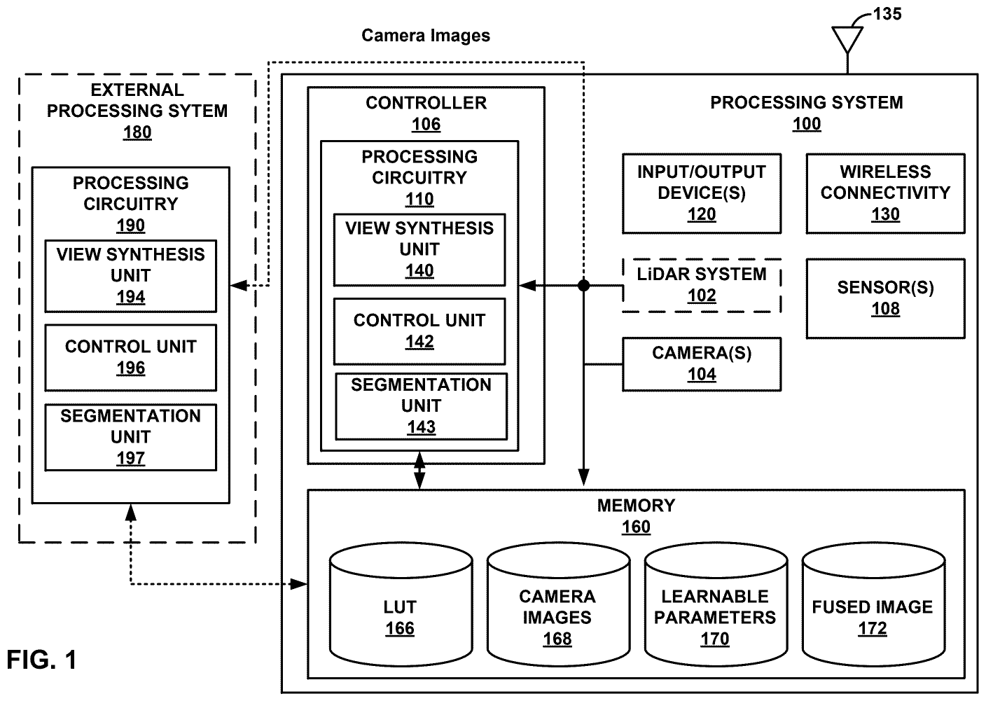

FIG. 1 is a block diagram illustrating an example processing system 100, in accordance with one to more techniques of this disclosure. Processing system 100 may be used in a vehicle, such as an autonomous driving vehicle or an assisted driving vehicle (e.g., a vehicle having an advanced driver-assistance systems (ADAS) or an “ego vehicle”). In such an example, processing system 100 may represent an ADAS.

While described with relation to an ADAS and BEV images, the techniques of this disclosure are not limited to processing image data in automotive contexts, or specifically with create BEV images. Processing system 100 may be applicable for use with any multi-camera and/or multi-sensor system where the output the cameras/sensors are used to create a fused, synthesized, and/or reconstructed output. That is, processing system 100 may be used for any view synthesis or view construction use case where a single output (e.g., fused image) with a mesh or grid structure is created from multiple sources. Examples may include extended reality (XR) systems, virtual reality (VR) systems, spherical or 3-D video, and others.

Processing system 100 may include LiDAR system 102 (optional), camera(s) 104, controller 106, one or more sensor(s) 108, input/output device(s) 120, wireless connectivity component 130, and memory 160. LiDAR system 102 may include one or more light emitters (e.g., lasers) and one or more light sensors. LiDAR system 102 may, in some cases, be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 is not limited to being deployed in or about a vehicle. LiDAR system 102 may be deployed in or about another kind of object.

In some examples, the one or more light emitters of LiDAR system 102 may emit such pulses in a 360-degree field around the vehicle so as to detect objects within the 360-degree field by detecting reflected pulses using the one or more light sensors. For example, LiDAR system 102 may detect objects in front of, behind, or beside LiDAR system 102. While described herein as including LiDAR system 102, it should be understood that another distance or depth sensing system may be used in place of LiDAR system 102. The output of LiDAR system 102 are called point clouds or point cloud frames.

Camera(s) 104 may be any type of camera configured to capture video or image data in the environment around processing system 100 (e.g., around a vehicle). In some examples, processing system 100 may include multiple cameras 104. For example, camera(s) 104 may include a front facing camera (e.g., a front bumper camera, a front windshield camera, and/or a dashcam), a back facing camera (e.g., a backup camera), side facing cameras (e.g., cameras mounted in sideview mirrors). Camera(s) 104 may be a color camera or a grayscale camera. In some examples, camera(s) 104 may be a camera system including more than one camera sensor. While techniques of this disclosure will be described with reference to a 2D photographic camera, the techniques of this disclosure may be applied to the outputs of other sensors, including a sonar sensor, a radar sensor, an infrared camera, and/or a time-of-flight (ToF) camera.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processing circuitry 110. Controller 106 is not limited to controlling vehicles. Controller 106 may additionally or alternatively control any kind of controllable object, such as a robotic component.

Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure. In some examples, one or more of processing circuitry 110 may be based on an Advanced Reduced Instruction Set Computer (RISC) Machine (ARM) or a RISC five (RISC-V) instruction set.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with LiDAR system 102, camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

Processing system 100 may be configured to perform techniques for generating a fused image (e.g., BEV image) having fused features from a plurality of different cameras or other sensors. For example, processing circuitry 110 may include view synthesis unit 140. View synthesis unit 140 may be implemented in software, firmware, and/or any combination of hardware described herein. As will be described in more detail below, view synthesis unit 140 may be configured to receive a plurality of camera images 168 captured by camera(s) 104. View synthesis unit 140 may extract a respective set of features from camera images 168 and may fuse the extracted features of the images into a single fused image having a grid structure (e.g., a BEV image). View synthesis unit 140 may be configured to receive camera images 168 from camera(s) 104 or from memory 160. View synthesis unit 140 may be configured to generate a fused image 172 (e.g., a BEV image) with fused features extracted from a plurality of a camera images 168. View synthesis unit 140 is configured to fuse the extracted features

Segmentation unit 143 may be configured to perform one or more 3D semantic segmentation and/or object detection processes on the fused features produced by view synthesis unit 140. Segmentation unit 143 may then use the fused point cloud for 3D semantic segmentation and/or object detection purposes. Examples of 3D image segmentation process may include one or more of object detection, object classification, thresholding segmentation, region-based segmentation, edge-based segmentation, clustering-based segmentation, semantic segmentation, or instance segmentation.

Processing circuitry 110 of controller 106 may apply control unit 142 to control an object (e.g., a vehicle, a robotic arm, or another object that is controllable by processing system 100) based on the output generated by view synthesis unit 140 and/or segmentation unit 143. Control unit 142 may control the object based on information included in the output generated by view synthesis unit 140 and/or segmentation unit 143 relating to one or more objects within a 3D space including processing system 100. For example, the output generated by view synthesis unit 140 and/or segmentation unit 143 may include an identity of one or more objects, a position of one or more objects relative to the processing system 100, characteristics of movement (e.g., speed, acceleration) of one or more objects, or any combination thereof. Based on this information, control unit 142 may control the object corresponding to processing system 100. The output from view synthesis unit 140 and/or segmentation unit 143 may be stored in memory 160.

The techniques of this disclosure may also be performed by external processing system 180. That is, encoding input data, transforming features into a fused image, weighing features, fusing features, and decoding features, may be performed by a processing system that does not include the various sensors shown for processing system 100. Such a process may be referred to as “offline” data processing, where the output is determined from a set of test point clouds and test images received from processing system 100. External processing system 180 may send an output to processing system 100 (e.g., an ADAS or vehicle).

External processing system 180 may include processing circuitry 190, which may be any of the types of processors described above for processing circuitry 110. Processing circuitry 190 may include a view synthesis unit 194 and segmentation unit 197 configured to perform the same processes as view synthesis unit 140 and segmentation unit 143. Control unit 196 may be configured to perform any of the techniques described as being performed by control unit 142. Processing circuitry 190 may acquire camera images 168 directly from camera(s) 104 or from memory 160. Though not shown, external processing system 180 may also include a memory.

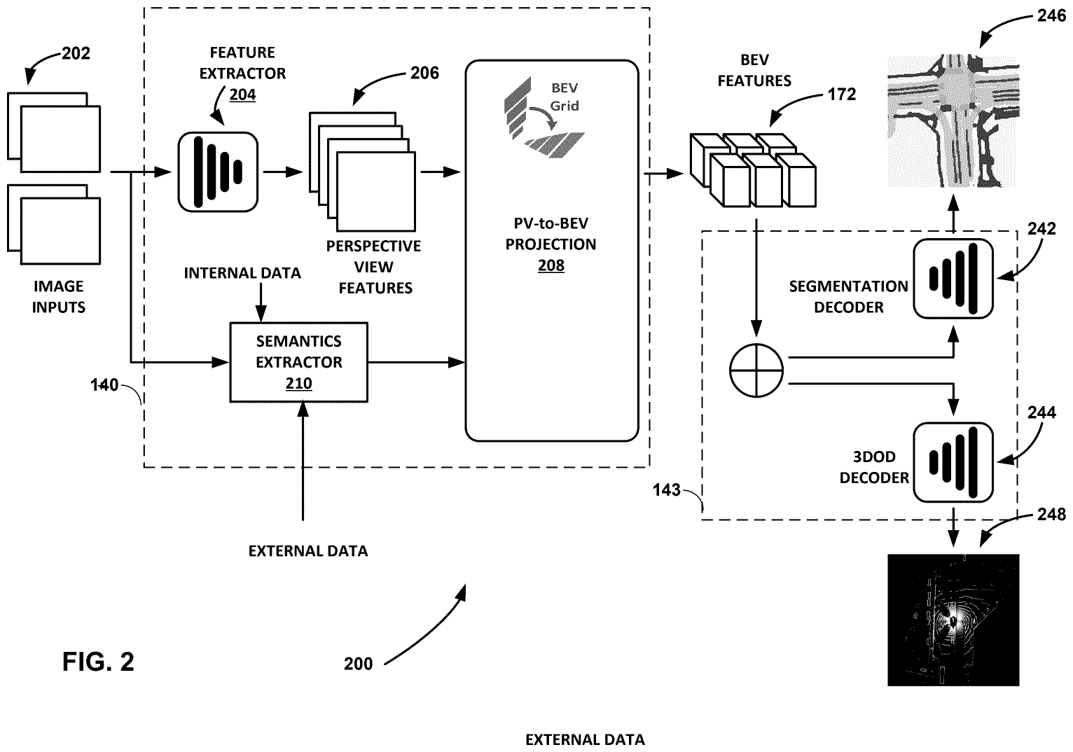

FIG. 2 is a block diagram illustrating an encoder-decoder architecture 200 for fusing features from multiple images and performing one or more segmentation techniques, in accordance with one or more techniques of this disclosure. Encoder-decoder architecture 200 is an example of processing circuitry 110 and/or processing circuitry 190 of FIG. 1 that may be configured to perform the techniques of this disclosure. In this example, encoder-decoder architecture 200 may include view synthesis unit 140 (or view synthesis unit 194) and segmentation unit 143 (or segmentation unit 197) of FIG. 1.

Encoder-decoder architecture 200 may receive camera images 202 as inputs. Camera images 202 may be camera images, captured for a same scene and at essentially the same time, from a plurality of different cameras at different locations and/or different fields of view which may be overlapping. For example, camera images 202 may be from the cameras having the FOVs depicted in FIG. 2 and/or may be camera images 168 of FIG. 1. In some examples, encoder-decoder architecture 200 processes camera images 202 in real time or near real time so that as camera(s) 104 (see FIG. 1) captures camera images 202, encoder-decoder architecture 200 processes the captured camera images. In some examples, camera images 202 may represent one or more perspective views of one or more objects within a 3D space where processing system 100 is located. That is, the one or more perspective views may represent views from the perspective of processing system 100.

Encoder-decoder architecture 200 includes encoder 204 (also referred to as feature extractor 204), decoder 242 (e.g., a segmentation decoder), and decoder 244 (e.g., a 3D object detection (3D0D) decoder). Encoder-decoder architecture 200 may be configured to process image data, but other types of sensor data may be processed in other examples. An encoder-decoder architecture for image feature extraction is commonly used in computer vision tasks, such as image captioning, image-to-image translation, and image generation. Encoder-decoder architecture 200 may transform input data into a compact and meaningful representation known as a feature vector (generally, “features”) that captures salient visual information from the input data. The term feature may generally refer to an abstract latent representation, which is learned during training, that captures certain patterns or characteristics of objects found in the images. The encoder may extract features from the input data, while the decoder reconstructs the input data from the learned features.

In some cases, encoder 204 is built using convolutional neural network (CNN) layers to analyze input data in a hierarchical manner. The CNN layers may apply filters to capture local patterns and gradually combine them to form higher-level features. Each convolutional layer extracts increasingly complex visual representations from the input data. These representations may be compressed and down sampled through operations such as pooling or strided convolutions, reducing spatial dimensions while preserving desired information. The final output of the encoder may represent a feature vector that encodes the input data's high-level visual features.

Decoder 242 and/or decoder 244 may be built using transposed convolutional layers or fully connected layers, may reconstruct the input data from the learned feature representation. A decoder may take the feature vector obtained from the encoder as input and processes it to generate an output that is similar to the input data. The decoder may up-sample and expand the feature vector, gradually recovering spatial dimensions lost during encoding. A decoder may apply transformations, such as transposed convolutions or deconvolutions, to reconstruct the input data. The decoder layers progressively refine the output, incorporating details and structure until a visually plausible image is generated.

During training, an encoder-decoder architecture for feature extraction is trained using a loss function that measures the discrepancy between the reconstructed image and the ground truth image. This loss guides the learning process, encouraging the encoder to capture meaningful features and the decoder to produce accurate reconstructions. The training process may involve minimizing the difference between the generated image and the ground truth image, typically using backpropagation and gradient descent techniques.

An encoder-decoder architecture for image feature extraction may comprise one or more encoders that extract high-level features from the input data and one or more decoders that reconstruct the input data from the learned features. This architecture may allow for the transformation of input data into compact and meaningful representations. The encoder-decoder framework may enable the model to learn and utilize important visual and positional features, facilitating tasks like image generation, captioning, and translation.

Encoder 204 may represent an encoder of a neural network or another kind of model that is configured to extract information from input data and process the extracted information to generate an output. In general, encoders are configured to receive data as an input and extract one or more features from the input data. The features are the output from the encoder. The features may include one or more vectors of numerical data that can be processed by a machine learning model. These vectors of numerical data may represent the input data in a way that provides information concerning characteristics of the input data. In other words, encoders are configured to process input data to identify characteristics of the input data.

In some examples, the encoder 204 represents a CNN, another kind of artificial neural network (ANN), or another kind of model that includes one or more layers and/or nodes. Each layer of the one or more layers may include one or more nodes. Examples of layers include input layers, output layers, and hidden layers between the input layers and the output layers. A CNN, for example, may include one or more convolutional layers comprising convolutional filters. Each convolutional filter may perform one or more mathematical operations on the input data to detect one or more features such as edges, shapes, textures, or objects. CNNs may additionally or alternatively include activation functions that identify complex relationships between elements of an image and pooling layers that recognize patterns regardless of location within the image frame.

Encoder 204 may extract a set of perspective view (PV) features 206 based on camera images 202. That is, encoder 204 may extract features from a respective image of camera images from each camera of a plurality of cameras (e.g., camera(s) 104 of FIG. 1). Perspective view features 206 may provide information corresponding to one or more objects depicted in camera images 202 from the perspective of camera(s) 104 which captures camera images 202. For example, perspective view features 206 may include vanishing points and vanishing lines that indicate a point at which parallel lines converge or disappear, a direction of dominant lines, a structure or orientation of objects, or any combination thereof. Perspective view features 206 may include color information. Additionally, or alternatively, perspective view features 206 may include key points that are matched across a group of two or more camera images of camera images 202. Key points may allow encoder-decoder architecture 200 to determine one or more characteristics of motion and pose of objects. Perspective view features 206 may, in some examples, include depth-based features that indicate a distance of one or more objects from the camera, but this is not required. Perspective view features 206 may include any one or combination of image features that indicate characteristics of camera images 202.

It may be beneficial for encoder-decoder architecture 200 to transform perspective view features 206 into BEV features that represent the one or more objects within the 3D environment on a grid structure from a perspective looking down at the one or more objects from a position above the one or more objects. Since encoder-decoder architecture 200 may be part of an ADAS for controlling a vehicle, and since vehicles move generally across the ground in a way that is observable from a bird's eye perspective, generating BEV features (e.g., fused features from multiple cameras) may allow a control unit (e.g., control unit 142 and/or control unit 196) of FIG. 1 to control the vehicle based on the representation of the one or more objects from a bird's eye perspective. Encoder-decoder architecture 200 is not limited to generating fused BEV features for controlling a vehicle. Encoder-decoder architecture 200 may generate fused features for controlling another object such as a robotic arm and/or perform one or more other tasks involving image segmentation, depth detection, object detection, or any combination thereof.

Projection unit 208 may transform perspective view features 206 into fused features in fused image 172. Such a transformation may be referred to as a PV-to-BEV projection. In some examples, projection unit 208 may generate a 2D grid and project the perspective view features 206 onto the 2D grid. For example, projection unit 208 may perform perspective transformation to place objects closer to the camera on the 2D grid and place objects further form the camera on the 2D grid. In some examples, the 2D grid may include a predetermined number of rows and a predetermined number of columns, but this is not required. Projection unit 208 may, in some examples, set the number of rows and the number of columns. In any case, projection unit 208 may generate the fused features (e.g., BEV features) in fused image 172 that represent information present in perspective view features 206 on a 2D grid including the one or more objects from a perspective above the one or more objects looking down at the one or more objects.

In some examples, projection unit 208 may use one or more self-attention blocks and/or cross-attention blocks to transform perspective view features 206 into the set of BEV features of fused image 172. Cross-attention blocks may allow projection unit 208 to process different regions and/or objects of perspective view features 206 while considering relationships between the different regions and/or objects. Self-attention blocks may capture long-range dependencies within perspective view features 206. This may allow a BEV representation of the perspective view features 206 to capture relationships and dependencies between different elements, objects, and regions in the BEV representation.

Projection unit 208 may, for example, perform non-transformer based PV-to-BEV or transformer-based PV-to-BEV utilizing push to 3D or pull from 2D techniques. For an existing push to 3D technique, a feature map of size (fH, fW, C) may be used to create a uniform (fH, fW) grid on each image, and calibration information may be used to lift features into 3D. In such a push technique, features are sampled uniformly, and the computational resources expended are proportional to fH×fW, which results in a lack of high resolution features and a sparsely population BEV grid.

For an existing pull from 2D technique, a feature map of size (fH, fW, C) may be used to create a uniform (X, Z) grid in BEV space, and calibration information may be used to pull features into 3D. In such a pull technique, sampling is performed based on interpolating a set of reference points in image features. The computational resources expended are proportional to the BEV map size (X×Y×Z), and the BEV grid is densely generated.

In addition to existing techniques for PV to BEV projection, encoder-decoder architecture 200 may also utilize non-uniform sampling and projection. For example, semantics extractor 210 may be configured to determine semantic characteristics for the input images, and projection unit 208 may be configured to perform PV to BEV projection non-uniformly based on one or more identified semantic characteristics. Semantics extractor 210 may be configured to determine semantic characteristics for the input images directly from the input images themselves, from other internal data, or from external data. In this context, internal data includes data known to processing system 100, and external data generally refers to data acquired from sources that are external to processing system 100. Examples of internal data include route data, path data, trajectory data, and the like, which may be known to an ADAS. Examples of external data include, for instance, map data (e.g., an HD map or SD map) that may be acquired from a database or V2X data that may be acquired from other vehicle, infrastructure, pedestrians, or other such sources.

In some examples, when obtaining the semantic characteristics directly from the input images, semantics extractor 210 may use perspective view segmentation or detection by, for example, using image domain semantic segmentation, key-point detection, or object detection to create the semantic priors. In some examples, semantics extractor 210 may use BEV semantic segmentation and occupancy prediction to obtain semantic priors for BEV grid sampling. In some examples, semantics extractor 210 may be configured to leverage vehicle-to-device signals to create the semantic priors. The device may be another vehicle, a central processing system, or the like. In some examples, semantics extractor 210 may be configured to use future predictions to create the semantic priors for sampling or PV to BEV projections. In some examples, semantics extractor 210 may be configured to use future plannings as the semantic priors for sampling or PV to BEV projections.

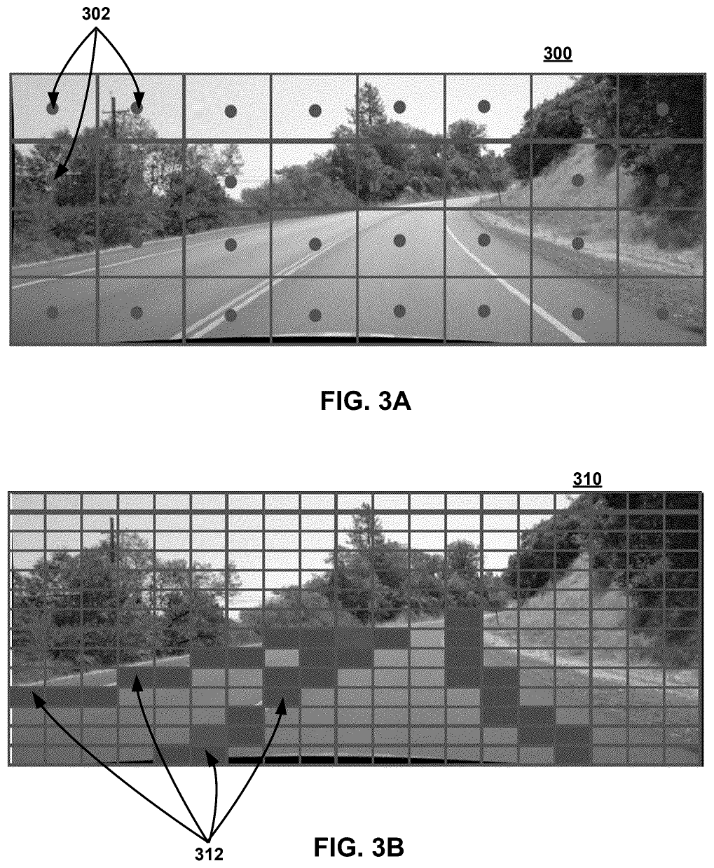

Based on the determined semantic priors, projection unit 208 may perform feature guided sampling that is independent of perspective view resolution. FIG. 3A shows an example of uniform sampling on a perspective view image. For example, image 300 can be divided into 32 (4×8) equal regions, with each region having one sample 302. In contrast, FIG. 3B shows an example of non-uniform sampling on a perspective view image in accordance with techniques of this disclosure. In the example of FIG. 3B, image 310 is divided into 266 (14×19) equal regions. While image 310 still has 32 samples, not every region has a sample, and the samples are not uniformly dispersed. Using non-uniform sampling, projection unit 208 may sample independently of grid resolution.

To implement a non-transformer push to 3D, after image feature extraction, projection unit 208 has multi-scale feature maps, which can be denoted as F1, F2, . . . , FN, with sizes of (x1, y1), (x2, y2), . . . (xN, yN). Projection unit 208 may select i-th feature map and project the i-th feature map uniformly into the BEV space, which helps to represent features beyond the semantic guidelines. Given a set of interesting semantic information, projection unit 208 may use a fixed number of samples and sample from any desired scale of feature map (depending on the compute budget). In some examples, projection unit 208 may use an image based multitask network. For example, semantics extractor unit 210 may use a coarse multitask network to create image based semantics, like bounding boxes for objects or keypoints for lanes and road, and use those as the semantics of interest for sampling. In some examples, semantics extractor unit 210 may use external inputs, like HD maps, and project the maps into the image (based on calibration) to use as semantics of interest.

Encoder-decoder architecture 200 may include further segmentation unit 143 that includes decoder 242 and decoder 244. In some examples, each of decoder 242 and decoder 244 may represent a CNN, another kind of ANN, or another kind of model that includes one or more layers and/or nodes. Each layer of the one or more layers may include one or more nodes. Examples of layers include input layers, output layers, and hidden layers between the input layers and the output layers. In some examples, a decoder may include a series of transformation layers. Each transformation layer of the set of transformation layers may increase one or more spatial dimensions of the features, increase a complexity of the features, or increase a resolution of the features. A final layer of a decoder may generate a reconstructed output that includes an expanded representation of the features extracted by an encoder.

Decoder 242 may be configured to generate a first output 246 based on the fused set of BEV features in fused image 172. The first output 246 may comprise a 2D BEV representation of the 3D environment corresponding to processing system 100. For example, when processing system 100 is part of an ADAS for controlling a vehicle, the first output 246 may indicate a BEV view of one or more roads, road signs, road markers, traffic lights, vehicles, pedestrians, and other objects within the 3D environment corresponding to processing system 100. This may allow processing system 100 to use the first output 246 to control the vehicle within the 3D environment.

Since the output from decoder 242 includes a bird's eye view of one or more objects that are in a 3D environment corresponding to encoder-decoder architecture 200, a control unit (e.g., control unit 142 and/or control unit 196 of FIG. 1) may use the output from decoder 242 to control an object (e.g., a vehicle, one or more robotic components) within the 3D environment. For example, when the output from decoder 242 indicates a vehicle ahead of a vehicle corresponding to processing system 100, the control unit may control the vehicle to change lanes to pass the other vehicle. In another example, when the output from decoder 242 indicates a stop sign ahead, the control unit may control the vehicle to stop at an intersection.

Decoder 244 may be configured to generate a second output 248 based on the fused set of BEV features of fused image 172. In some examples, the second output 248 may include a set of 3D bounding boxes that indicate a shape and a position of one or more objects within a 3D environment. In some examples, it may be important to generate 3D bounding boxes to determine an identity of one or more objects and/or a location of one or more objects. When processing system 100 is part of an ADAS for controlling a vehicle, processing system 100 may use the second output 248 to control the vehicle within the 3D environment. A control unit (e.g., control unit 142 and/or control unit 196 of FIG. 1) may process the second output 248 to perform one or more actions.

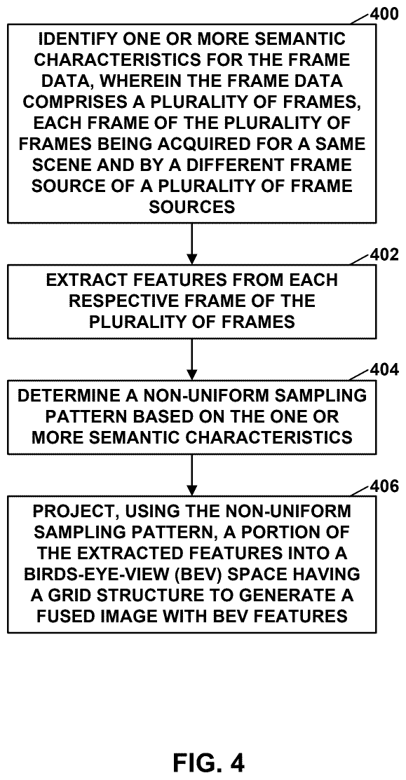

FIG. 4 is a flowchart illustrating an example process for projecting extracted features into a BEV space in accordance with the techniques of this disclosure. Although described with respect to processing system 100 (FIG. 1), it should be understood that other devices may be configured to perform a process similar to that of FIG. 4.

In the example of FIG. 4, processing system 100 identifies one or more semantic characteristics for frame data. The frame data may, for example, include a plurality of frames with each frame of the plurality of frames being acquired for a same scene and by a different frame source of a plurality of frame sources. It is contemplated that plurality of frames acquired for the same scene may be acquired at essentially the same time but perhaps not at exactly the same time. In some examples, the frame data is image data, the plurality of frames are a plurality of images, and the plurality of frame sources are a plurality of cameras. In some examples, the frame data is radar data, the plurality of frames are a plurality of radar frames, and the plurality of frame sources are a plurality of radar devices. In some examples, the frame data is LiDAR data, the plurality of frames are a plurality of LiDAR frames, and the plurality of frame sources are a plurality of LiDAR devices. In some examples, the frame data may be a mixture of images, radar frames, and LiDAR frames.

To identify the one or more semantic characteristics for the frame data, processing system 100 may be configured to perform object detection on the frame data to identify an object belonging to a predetermined class of objects. For example, processing system 100 may identify lane markers that define a path a vehicle is travelling, moving objects in or near a path the vehicle is travelling, or fixed objects in the proximity of the path the vehicle is travelling.

To identify the one or more semantic characteristics for the frame data, processing system 100 may be configured to retrieve the one or more semantic characteristics from a database based on a location of where the frame data was acquired or from a VSX source. For example, processing system 100 may receive map data from a source external to processing system 100 and use the map data to identify the presence of structures, traffic signs and signals, or other such features in the vicinity of the area where the frame data was acquired.

To identify the one or more semantic characteristics for the frame data, processing system 100 may be configured to receive the one or more semantic characteristics from an ADAS. For example, the ADAS, which may be part of processing system 100 or separate from processing system 100, may transmit to processing system 100 an intended direction of travel or an intended speed change.

Processing system 100 extracts features from each respective frame of the plurality of frames (402). As explained in more detail above, processing system 100 may extract a set of PV features from the frame data.

Processing system 100 determines a non-uniform sampling pattern of the plurality of frames based on the one or more semantic characteristics (404). As one example, if the one or more semantic characteristics are the presence of lane markers, then processing system 100 may perform more sampling inside the lane markers compared to outside the lane markers. If the one or more semantic characteristics are the presence of a fixed object such as a curb, then processing system may perform more sampling inside the curb, e.g., on a road compared to outside the lane markers. If the one or more semantic characteristics are that a path being followed by the vehicle veers to the right, then processing system 100 may perform more sampling toward the right of a centerline of the vehicle compared to left of the centerline of the vehicle. If the one or more semantic characteristics are the presence traffic signs or traffic lights, then processing system 100 may perform more sampling at those locations. If the one or more semantic characteristics are the presence complex environments or traffic critical places like junctions, intersections, crossroads, then processing system 100 may perform more sampling at those locations. Essentially, any location within a scene that is deemed to be of greater importance and that is identifiable by one or more semantic characteristics may be sampled by processing system 100 with a higher sampling rate.

Processing system 100 projects, using the non-uniform sampling pattern, a portion of the extracted features into a BEV space having a grid structure to generate a fused image with BEV features (406). Processing system 100 may be configured to uniformly project another portion of the extracted features into the BEV space having the grid structure. In some examples, processing system 100 may uniformly project the extracted features into the BEV space in conjunction with a non-uniform projection. For example, on a set of perspective view features, processing system 100 may first perform uniform projection as described with respect to FIG. 3A followed by non-uniform projection as described with respect to FIG. 3B.

Processing system 100 may apply, to the BEV features, an object detection decoder to generate a set of bounding boxes that indicate a location of one or more objects within the fused image and may apply, to the fused image, a segmentation decoder to identify types of objects in the BEV features. Various modules, such as a tracking module for tracking objects, a prediction module for predicting future trajectories of objects, or a planning module for planning the future trajectory may also use the BEV features in performing various tasks. Processing system 100 may, for example, use the identification of the objects in determining how to control a vehicle.

Additional aspects of the disclosure are detailed in numbered clauses below.

Clause 1: An apparatus for processing frame data, the apparatus comprising: a memory for storing the frame data; and processing circuitry in communication with the memory, wherein the processing circuitry is configured to: identify one or more semantic characteristics for the frame data, wherein the frame data comprises a plurality of frames, each frame of the plurality of frames being acquired for a same scene and by a different frame source of a plurality of frame sources; extract features from each respective frame of the plurality of frames; determine a non-uniform sampling pattern of the plurality of frames based on the one or more semantic characteristics; and project, using the non-uniform sampling pattern, a portion of the extracted features into a bird's-eye-view (BEV) space having a grid structure to generate a fused set of BEV features.

Clause 2: The apparatus of clause 1, wherein to identify the one or more semantic characteristics for the frame data the processing circuitry is configured to perform object detection on the frame data to identify an object belonging to a predetermined class of objects.

Clause 3: The apparatus of clause 1 or 2, wherein to identify the one or more semantic characteristics for the frame data the processing circuitry is configured to retrieve the one or more semantic characteristics from a database based on a location of where the frame data was acquired.

Clause 4: The apparatus of any of clauses 1-3, wherein to identify the one or more semantic characteristics for the frame data the processing circuitry is configured to receive the one or more semantic characteristics from an advanced driver assistance system (ADAS) or an autonomous driving (AD) system.

Clause 5: The apparatus of any of clauses 1-4, the processing circuitry is further configured to uniformly project another portion of the extracted features into the BEV space having the grid structure.

Clause 6: The apparatus of any of clauses 1-5, wherein the frame data comprises image data, the plurality of frames comprises a plurality of images, and the plurality of frame sources comprises a plurality of cameras.

Clause 7: The apparatus of any of clauses 1-6, wherein the frame data comprises radar data, the plurality of frames comprises a plurality of radar frames, and the plurality of frame sources comprises a plurality of radar devices.

Clause 8: The apparatus of any of clauses 1-7, wherein the frame data comprises LiDAR data, the plurality of frames comprises a plurality of LiDAR frames, and the plurality of frame sources comprises a plurality of LiDAR devices.

Clause 9: The apparatus of any of clauses 1-8, wherein the processing is circuitry is further configured to: apply, to the fused set of BEV features, an object detection decoder to generate a set of bounding boxes that indicate a location of one or more objects within the BEV space.

Clause 10: The apparatus of any of clauses 1-9, wherein the processing is circuitry is further configured to: apply, to the fused set of BEV features, a segmentation decoder to identify types of objects in the fused set of BEV features.

Clause 11: The apparatus of any of clauses 1-10, wherein the processing circuitry and the memory are part of an advanced driver assistance system (ADAS) or an autonomous driving (AD) system.

Clause 12: A method for processing frame data, the method comprising: identifying one or more semantic characteristics for the frame data, wherein the frame data comprises a plurality of frames, each frame of the plurality of frames being acquired for a same scene and by a different frame source of a plurality of frame sources; extracting features from each respective frame of the plurality of frames; determining a non-uniform sampling pattern of the plurality of frames based on the one or more semantic characteristics; and projecting, using the non-uniform sampling pattern, a portion of the extracted features into a bird's-eye-view (BEV) space having a grid structure to generate a fused set of BEV features.

Clause 13: The method of clause 12, wherein identifying the one or more semantic characteristics for the frame data, comprises performing object detection on the frame data to identify an object belonging to a predetermined class of objects.

Clause 14: The method of clause 12 or 13, wherein identifying the one or more semantic characteristics for the frame data, comprises retrieving the one or more semantic characteristics from a database based on a location of where the frame data was acquired.

Clause 15: The method of any of clauses 12-14, wherein identifying the one or more semantic characteristics for the frame data, comprises receiving the one or more semantic characteristics from an advanced driver assistance system (ADAS) or an autonomous driving (AD) system.

Clause 16: The method of any of clauses 12-15, further comprising: uniformly projecting another portion of the extracted features into the BEV space having the grid structure.

Clause 17: The method of any of clauses 12-16, wherein the frame data comprises image data, the plurality of frames comprises a plurality of images, and the plurality of frame sources comprises a plurality of cameras.

Clause 18: The method of any of clauses 12-17, wherein the frame data comprises LiDAR data, the plurality of frames comprises a plurality of LiDAR frames, and the plurality of frame sources comprises a plurality of LiDAR devices.

Clause 19: The method any of clauses 12-18, further comprising: applying, to the BEV features, an object detection decoder to generate a set of bounding boxes that indicate a location of one or more objects within the BEV space.

Clause 20: The method of any of clauses 12-19, further comprising: applying, to the BEV features, a segmentation decoder to identify types of objects in the BEV features.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for processing frame data, the apparatus comprising:
a memory for storing the frame data; and
processing circuitry in communication with the memory, wherein the processing circuitry is configured to:
identify one or more semantic characteristics for the frame data, wherein the frame data comprises a plurality of frames, each frame of the plurality of frames being acquired for a same scene and by a different frame source of a plurality of frame sources;
extract features from each respective frame of the plurality of frames;
determine a non-uniform sampling pattern of the plurality of frames based on the one or more semantic characteristics; and
project, using the non-uniform sampling pattern, a portion of the extracted features into a bird's-eye-view (BEV) space having a grid structure to generate a fused set of BEV features.

2. The apparatus of claim 1, wherein to identify the one or more semantic characteristics for the frame data, the processing circuitry is configured to perform object detection on the frame data to identify an object belonging to a predetermined class of objects.

3. The apparatus of claim 1, wherein to identify the one or more semantic characteristics for the frame data, the processing circuitry is configured to retrieve the one or more semantic characteristics from a database based on a location of where the frame data was acquired.

4. The apparatus of claim 1, wherein to identify the one or more semantic characteristics for the frame data, the processing circuitry is configured to receive the one or more semantic characteristics from an advanced driver assistance system (ADAS) or an autonomous driving (AD) system.

5. The apparatus of claim 1, the processing circuitry is further configured to uniformly project another portion of the extracted features into the BEV space having the grid structure.

6. The apparatus of claim 1, wherein the frame data comprises image data, the plurality of frames comprises a plurality of images, and the plurality of frame sources comprises a plurality of cameras.

7. The apparatus of claim 1, wherein the frame data comprises radar data, the plurality of frames comprises a plurality of radar frames, and the plurality of frame sources comprises a plurality of radar devices.

8. The apparatus of claim 1, wherein the frame data comprises LiDAR data, the plurality of frames comprises a plurality of LiDAR frames, and the plurality of frame sources comprises a plurality of LiDAR devices.

9. The apparatus of claim 1, wherein the processing is circuitry is further configured to:
apply, to the fused set of BEV features, an object detection decoder to generate a set of bounding boxes that indicate a location of one or more objects within the BEV space.

10. The apparatus of claim 1, wherein the processing is circuitry is further configured to:
apply, to the fused set of BEV features, a segmentation decoder to identify types of objects in the fused set of BEV features.

11. The apparatus of claim 1, wherein the processing circuitry and the memory are part of an advanced driver assistance system (ADAS) or an autonomous driving (AD) system.

12. A method for processing frame data, the method comprising:
identifying one or more semantic characteristics for the frame data, wherein the frame data comprises a plurality of frames, each frame of the plurality of frames being acquired for a same scene and by a different frame source of a plurality of frame sources;
extracting features from each respective frame of the plurality of frames;
determining a non-uniform sampling pattern based on the one or more semantic characteristics; and
projecting, using the non-uniform sampling pattern, a portion of the extracted features into a bird's-eye-view (BEV) space having a grid structure to generate a fused set of BEV features.

13. The method of claim 12, wherein identifying the one or more semantic characteristics for the frame data, comprises performing object detection on the frame data to identify an object belonging to a predetermined class of objects.

14. The method of claim 12, wherein identifying the one or more semantic characteristics for the frame data, comprises retrieving the one or more semantic characteristics from a database based on a location of where the frame data was acquired.

15. The method of claim 12, wherein identifying the one or more semantic characteristics for the frame data, comprises receiving the one or more semantic characteristics from an advanced driver assistance system (ADAS) or an autonomous driving (AD) system.

16. The method of claim 12, further comprising:
uniformly projecting another portion of the extracted features into the BEV space having the grid structure.

17. The method of claim 12, wherein the frame data comprises image data, the plurality of frames comprises a plurality of images, and the plurality of frame sources comprises a plurality of cameras.

18. The method of claim 12, wherein the frame data comprises LiDAR data, the plurality of frames comprises a plurality of LiDAR frames, and the plurality of frame sources comprises a plurality of LiDAR devices.

19. The method of claim 12, further comprising:
applying, to the fused set of BEV features, an object detection decoder to generate a set of bounding boxes that indicate a location of one or more objects within the BEV space.

20. The method of claim 12, further comprising:
applying, to the fused set of BEV features, a segmentation decoder to identify types of objects in the fused set of BEV features.
